(19) United States
(12) Patent Application Publication
(10) Pub. No.: US 2008/0218817 A1
(43) Pub. Date: Sep. 11, 2008

(54) SYSTEM AND METHOD FOR MAKING SEAMLESS HOLOGRAMS, OPTICALLY VARIABLE DEVICES AND EMBOSSING SUBSTRATES

(76) Inventors: Robert K. Grygier, Newark, DE (US); Sergey Broude, Newton, MA (US); Pascal Miller, Groton, MA (US); Andrew Wilkie, Avondale, PA (US); David Holbrook, Lexington, MA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/683,209

(22) Filed: Mar. 7, 2007

(51) Int. Cl. G03H 1/08

(52) U.S. Cl. 359/9

(57) ABSTRACT

Apparatus and method for producing optically variable devices, optically variable media, dot matrix holograms or embossing substrates. The system includes: a laser beam generator, a laser beam shaper, a spatial light modulator, imaging optics and an image positioner. The laser beam generator generates a laser beam, which is shaped by the laser beam shaper to modify the laser beam to an optimized beam profile. The shaped laser beam is modulated by the spatial light modulator, which generates, at a place removed from the substrate surface, an optical pattern. The imaging optics causes the optical pattern to be imaged on the substrate surface. An image positioner allows for the optical pattern to be positioned to different areas of the substrate surface. The system can produce adapted optically variable devices, optically variable media, dot matrix holograms or embossing substrates

### FIELD OF THE INVENTION

This invention relates to optical techniques for writing holographic patterns and optically variable devices onto a surface, including the apparatus for doing so and the method of utilizing that apparatus. More specifically it relates to the generation of seamless artwork and embossing tools for holographic films.

### BACKGROUND OF THE INVENTION

A variety of techniques for producing holograms and optically variable devices have been developed. These prior art techniques involve the interference of two or more beams of coherent monochromatic light at the surface of a photosensitive material where the hologram is produced. The monochromatic light is usually produced by a laser and depending on the desired result, the photosensitive material can be chosen to produce a surface relief, phase, polarization, or gray scale holographic pattern.

### Optically Variable Devices and Media

Optically variable devices (OVD) are optical devices, which diffract, refract, transmit, absorb, or scatter light and whose optical properties can vary within that device. Some examples of OVD would be holographic films, holograms, diffraction gratings, embossed films, original artwork, embossing rolls, and replicas. Optically variable media (OVM) are optical media, which diffract, refract, transmit, absorb, or scatter light and whose optical properties can vary within that device. Some examples of OVM which can be used to make OVD would be polymers, polymer films, multilayer films, films with inclusions, films with embossing layers, photoresist, epoxies, silicones, lacquers, cellulose triacetate, glasses, and optical materials.

The optical characteristics of OVD or OVM means the optical properties, which are measured by the method proposed here, and that relate directly to the “desired” or “target” values that are attainable based on specific applications or customer requirements. For example, the diffraction efficiency of an OVD or OVM can be measured and compared to the “desired” or “target” values that a customer requires. This information could be used to control a manufacturing process to produce the desired OVD or OVM or to set quality standards.

The visual appearance of OVD or OVM means the optical properties, which are measured by the method proposed here, and that relate directly to the “perceived visual effect” that is desired by a customer, artwork designer, or process control person. For example, the diffraction efficiency of an OVD or OVM that is found to be desirable due to its “perceived visual effect” can be controlled in the manufacturing process. In addition, an artwork designer could produce original artwork, which utilizes this desirable “perceived visual effect”.

An example of holographic or optically variable devices can be found in U.S. Pat. No. 5,032,003. This terminology is also mentioned in U.S. Pat. Pub. No. US 2005/0112472 A1. An example of holographic or optically variable materials can be found in U.S. Pat. No. 5,781,316 and U.S. Pat. Pub. No. US 2004/0101982 A1. Additional references pertinent to the field of the invention include, U.S. patents: U.S. Pat. Nos. 4,455,061; 4,498,740; 4,547,037; 4,778,262; 4,984,824; 5,032,003; 5,058,992; 5,138,471; 5,191,449; 5,262,879; 5,291,027; 5,291,317; 5,428,479; 5,521,030; 5,781,316; 5,822,092; 5,986,781; 5,999,280; 6,043,913; 6,297,894; 6,388,780; 6,486,982; 6,549,309; 6,567,193; 6,707,585; 6,930,811; 7,009,742; 7,042,605; 7,046,409; 7,049,617; U.S. Published Patent Applications: 20030058490; 20030148192; 20030156308; 20040012833; 20040050280; 20040101982; 20040240015; 20040263929; 20050112472; 20050094230; 20050185233; 20050200924; 20050200925; 20060002274; 20060007512; 20060013104; 20060039051; 20060098005; 20060098260; and Foreign Patent publications WO 97/16772 and WO 98/29767. All of these references stated herein are incorporated by reference.

### Prior Art Systems for Production of Holograms

Holograms of a variety of objects and patterns have been made using a single exposure to produce the desired final hologram. However, due to the cost and impracticality of the large optical systems needed, the size of these holograms is typically limited to about 1 square foot in size or smaller. Larger area holograms can be produced by a step-and-repeat procedure that tiles the pattern across the surface of the photosensitive material. This tiling, however, introduces seams or discontinuities between the adjacent areas, which are undesirable.

To solve some of these problems, Dot Matrix Holography was developed in the mid-1980s by Frank S. Davis at Advanced Holographics, Inc. Representative patents disclosing dot matrix holography are identified and incorporated by reference herein above. In dot matrix holography, a larger holographic pattern is constructed by producing a large number of small holographic dots or pixels in a regular two-dimensional array. These dots are on the order of 10's to 100's of microns in size and there can be as few as 100 dots per linear inch or many as 2,000 or more dots per linear inch (4,000,000 or more dots per square inch).

The fundamental principle of current embodiments of dot matrix holography involves the use of a laser beam, which is first split into two beams. These beams are then recombined at the recording material to create an interference pattern in small areas (holographic dots). Changing the angle and orientation of the intersecting laser beams controls the period and orientation of the resultant gratings produced in the recording material. Writing many thousands of these dots with the desired properties, in a similar manner to how a dot matrix printer creates a printed image, produces complex dot matrix holographic designs. One representative patent disclosing this process is U.S. Pat. No. 6,388,780.

The system, which produces the dot matrix holograms, is usually computer controlled. In each dot a grating is written with a desired different grating period, grating depth or grating orientation. In this way virtually any pattern can be produced. Because, each dot is controlled, the brightness, viewing angle, and color content of each dot can be adjusted. This allows a variety of visual effects to be produced. Brightness control allows gray scale or color type images to be made. Viewing angle control allows a wide variety of potential viewing angles. Kinetic effects can make an image appear to move or change as the hologram is tilted or the viewer shifts position. 3D effects can be made which make an image appear to come out of or be recessed into the surface of the hologram.

Because of the time and expense to produce dot matrix holograms, they are typically produced as masters, which are replicated to produce the final holographic product. The most widespread method of replication for production is embossing into a polymer film. To do this, the dot matrix holograms need to be surface relief holograms. These surface relief holograms are produced by interfering two laser beams onto a photosensitive material, which is typically a photoresist. After this exposure, the photoresist is developed to produce a final surface relief hologram. This is the master artwork, which is then typically replicated into a triacetate or metal shim to produce a sub-master. This sub-master may be used for direct embossing or it may be replicated a second or even third time to produce the final artwork that will be used for embossing.

The current embodiments of dot matrix holography described above have limitations. The use of two beams interfering at the recording material can reduce the quality and uniformity of the gratings that are written. Depending on the holographic dot matrix system design, the two beams typically have Gaussian intensity profiles to allow the beams to propagate without spreading and to allow them to be well focused at the recording material. The two beams need to be directed to the exact same location, so that they are well overlapped to produce the desired interference fringes. Even if the beams are perfectly overlapped, the illumination in the holographic dot will not be uniform due to the Gaussian profiles of the beams. The variation in illumination and the precision of overlap cause the depth of the written gratings to vary within the holographic dot. This produces a grating, which is not at the optimum or desired diffraction efficiency across the whole dot. To produce the best quality dot matrix holograms, each holographic dot or pixel should be of a uniform grating depth.

Also, since two beams are used in prior art dot matrix holography, each beam may focus differently at the dot location. This is due to the fact that each beam may have a slightly different size, shape or divergence. This will cause variation in the gratings produced, since the fringe visibility will vary across the holographic dot.

The two beams in prior art systems must also be coherent with each other to produce stable, high contrast fringes. Since the two beams must take separate paths to the location of the dot, the path length difference between the two paths must be less than the coherence length of the laser. If the path length difference is comparable or larger than the laser coherence length, no fringes will be produced or the fringes will have a very low contrast. Vibrations, which independently affect the two path lengths, can cause the fringes to move and so wash-out the writing of the grating. This requires that prior art two-beam systems must have a high degree of stability and vibration isolation.

For prior art systems using pulsed lasers, the two beams must also overlap in time. The pulses from each beam must arrive at the location of the dot at the same time. For pulsed lasers with nanosecond or longer pulses, this is not a problem, since a 1-nanosecond pulse is about 30 centimeters long. This requires the path differences of the two beams to be within a few centimeters. However, if a picosecond or shorter pulse is used, maintaining an acceptable path difference becomes a challenge. A 1-picosecond pulse is about 300 μm long. The required path difference is then less than a few tens of μm which is very difficult to maintain without precise mechanical, thermal and vibration controls. A picosecond or femtosecond laser is desirable for creating holographic gratings by direct laser ablation.

In addition, the relief of the individual gratings should be controlled to produce optimum results. Interfering two beams produces fringes whose intensity profiles are typically sinusoidal. The final relief of the gratings depends on this profile as well as on the physical or chemical process(es) occurring in the recording material. A sinusoidal profile may not be the optimum or desired shape. If a grating is produced by laser ablation rather than by using a photoresist, fringes with sinusoidal intensity profile may produce gratings which are more rectangular in relief profile. The ability to control the fringe visibility and profile of the gratings is limited when overlapping two beams. Better control of these parameters is important in producing the most uniform and highest quality gratings.

It is also desirable to control grating depth precisely. The variations due to the exposure control and development process with photoresists make it difficult for prior art embodiments of dot matrix holography to produce artwork with a consistent grating depth across the entire holographic artwork. This can result in variations in the visual appearance of the artwork. The overall uniformity and brightness of the whole holographic artwork can vary significantly. This produces defects, which are not acceptable for final products. Prior art embodiments of dot matrix holography, which use direct laser ablation to produce the holographic artwork, also do not have the control necessary to correct this problem.

It is also desirable to control the size, shape, location, and boundaries of the holographic dots. It is desirable to have the dots completely fill the area of the hologram. This means that the dots should be all of the same size and a shape such as square or hexagonal, which are complete space-filling shapes. The dots should also be precisely located and have sharp boundaries so that the gaps and overlaps between adjacent dots will be small compared to the dot size and invisible to the human eye. These characteristics would allow the production of defect-free and seamless holographic artwork. Prior art embodiments of dot matrix holography described above do not have this level of precision due to limitations discussed above.

Another disadvantage of prior art two-interfering beam embodiments of dot matrix holography is that the speed of writing the dots is limited due to the design. Changing the angle between the two beams at the dot location controls the grating period and orientation. This is typically accomplished by a pair of galvo scanners, which direct each beam independently to the dot location and define the angle at which they interfere with each other. The next dot location is then written by mechanically moving the substrate to a new location. This mechanical translation is slow compared to optical deflection and electro-optical techniques. Implementing optical deflection and electro-optical techniques to quickly move to a new dot location is difficult with the prior art designs.

Finally, prior art systems are designed to write only gratings in each dot location. There are significant advantages to being able to write other types of patterns, logos, letters, etc. in each dot. These types of patterns could be used for security applications as well as to make other types of diffracting elements such as bidirectional gratings, Fresnel lenses, white light gratings, 3D effects, etc.

### SUMMARY OF THE INVENTION

In an exemplary embodiment, the invention provides a system for treating a substrate surface to produce optically variable devices, optically variable media, dot matrix holograms or embossing substrates. The system includes: a laser beam generator, a laser beam shaper, a spatial light modulator, imaging optics and an image positioner. The laser beam generator generates a laser beam, which is shaped by the laser beam shaper to modify the laser beam to an optimized beam profile. The shaped laser beam is modulated by the spatial light modulator, which generates, at a place removed from the substrate surface, an optical pattern. The imaging optics causes the optical pattern to be imaged on the substrate surface. An image positioner allows for the optical pattern to be positioned to different areas of the substrate surface. The system can produce optically variable devices, optically variable media, dot matrix holograms or embossing substrates. In a further embodiment, the system can also include a debris remover for removing material that has been ablated from the substrate. In a further embodiment, the system can include an image monitoring sensor for monitoring the image produced on the substrate.

Other advantages and novel features of the invention will become apparent to those skilled in the art upon examination of the following detailed description of a preferred embodiment of the invention and the accompanying drawings.

### DESCRIPTION OF THE DRAWINGS

FIG. 1 is a block diagram of an exemplary system for producing optically variable devices, optically variable media, dot matrix holograms or embossing substrates.

FIG. 2 is a diagram of the light path through a Fabry-Perot Interferometer.

FIG. 3 is an illustration of how a Fabry-Perot Etalon varies the period and orientation of bright and dark optical interference fringes.

FIG. 4 is a diagram of one axis of an exemplary mask-based scanning system

FIG. 5 is an illustration of the operation of an exemplary Twyman Green or Michelson Interferometer.

FIG. 6 is an illustration of an exemplary high-speed pattern generation and writing method.

FIG. 7 is an illustration of exemplary holographic gratings, including sinusoidal, clipped sinusoidal, rectangular, and bi-axial (rainbow).

FIG. 8 is an illustration of an exemplary dot matrix arrangement of square holographic gratings.

FIG. 9 is an illustration of an exemplary dot matrix arrangement of circular holographic gratings.

FIG. 10 is a scanning electron micrograph of exemplary dot matrix gratings produced by laser ablation in PEEK polymer in accordance with an embodiment of this invention.

FIG. 11 is a microscope picture of 0.25 μm grooves in PEEK polymer produced in accordance with an embodiment of this invention.

FIG. 12 is a microscope picture of 0.5 μm grooves in PEEK polymer produced in accordance with an embodiment of this invention.

### DESCRIPTION OF THE PREFERRED EMBODIMENT OF THE INVENTION

The present invention addresses the above-described needs and limitations by using a single beam to generate the interference fringes or patterns at a location removed from the recording material surface and then imaging those fringes or patterns onto the recording material surface.

Because this present invention is a single beam system, the beam intensity can be made uniform over the whole dot and the size, shape and location of the dots can be more precisely controlled. This means that the gratings can be written uniformly within each dot and that the dots can fill nearly 100% of the area without significant overlap or gap between dots. This gives the ability to make bright, seamless and defect-free holographic artwork.

In addition, the grating depth and profile can be more precisely controlled in a single beam system. Adjusting the intensity of the single beam can control the grating depth. For a pulsed laser, the number of laser pulses can be used to adjust the grating depth as well. The grating profile can also be changed by adjusting the fringe visibility of the single beam. Controlling a single beam can be done more precisely than controlling the intensity, divergence, uniformity and angle of incidence of two beams.

The control of path differences as compared with the laser coherence length needed for the present invention is also less stringent than for two-beam embodiments. The path differences required to produce the interference fringes are much less because they occur in a microscopic scale. This also makes the system less sensitive to vibrations, thermal drift and variation in mechanical stability. In addition, the smaller path differences make using a picosecond or femtosecond laser possible, since all parts of the final beam are traveling along the same direction.

The systems and methods disclosed herein allow higher speed writing of the dots by implementing optical deflection and electro-optical techniques. This allows the dots to be written very quickly in a subfield and then the holographic substrate is moved to another subfield using slower, mechanical, translation. In this way, the total speed to cover large area holographic designs is increased and optimized.

The systems and methods disclosed herein also allow writing other types of patterns, logos, letters, etc. in each dot. These types of patterns can be used for security applications as well as to make other types of diffracting elements such as bidirectional gratings, Fresnel lenses, white light gratings, 3D effects, etc.

The systems and methods disclosed herein can produce optically variable devices, optically variable media, dot matrix holograms or embossing substrates on curved surfaces as well as flat surfaces, including embossing rolls. The holographic artwork can be bright, seamless and defect-free. They can also be made with lasers that either ablate the patterns into the surface of the substrate or use a photochemical process (with photoresists, etc.) to create the patterns. A variety of materials can be used as the substrate including: polymers, photoresists, metals, ceramics, etc. These designs have direct application to holographic artwork and embossing into polymer films but have other applications to producing holographic optical elements for a wide variety of technical applications.

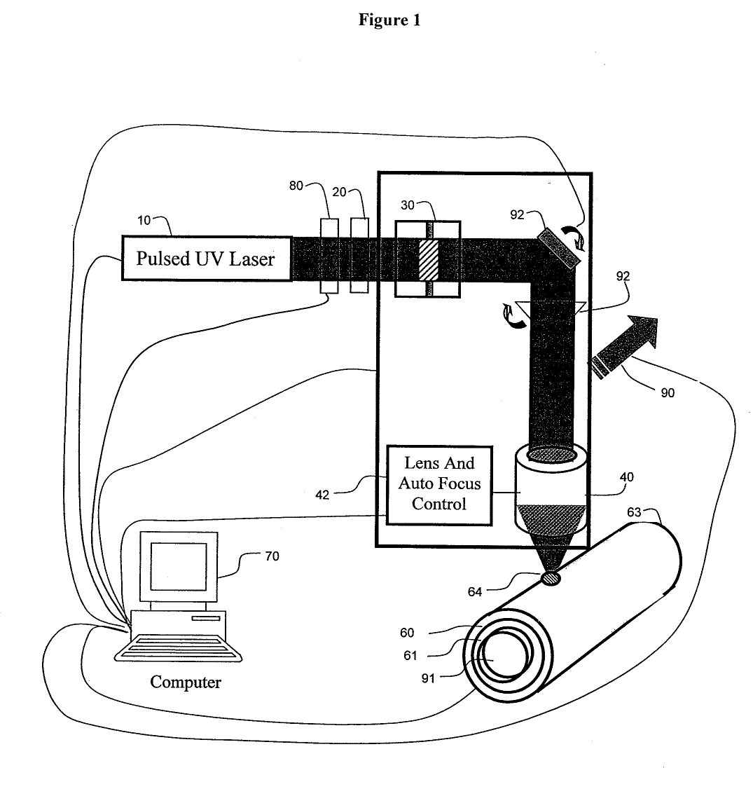

Referring now to various figures of the drawings wherein like reference characters refer to like parts, there is shown in FIG. 1, a block diagram of an exemplary embodiment of a system for manufacture of optically variable devices. Shown in FIG. 1 are a laser beam generator 10, a laser beam shaper 20, a spatial light modulator 30, imaging optics 40, comprising a lens and autofocus control 42, a laser beam control 80 and an image positioner comprising a linear translation stage 90 and galvo or electro optical scanners 92. The laser beam generator 10 consists of a laser, which can be a pulsed or CW (continuous wave) laser depending on the whether laser ablation material or a photosensitive material is used as the substrate. The laser beam is made into a uniform flat intensity with, for example, a square shape by the beam shaper 20. A beam control device 80 turns the laser beam on and off under computer control. A grating or other pattern is generated by a spatial light modulator 30. The spatial light modulator can comprise any one of a number of devices including: a Fabry-Perot Etalon, a mask, a Liquid Crystal Display (LCD), Digital Micro-Mirror Device, or a Twyman-Green (or Michelson) Interferometer. The laser beam is directed through a lens 40, which images the grating or other pattern onto the substrate surface 63. In this example, the substrate surface 63 is part of a cylinder sleeve 60, that is mounted on a cylinder mandrel 61.

The pattern 64 shown on the surface 63 represents a single dot of a dot matrix hologram. An autofocus control 42, which is shown in this example connected to the lens assembly 40, ensures that the image is always in focus on the substrate surface 63 for each dot that is written. The location of the dot 64 on the substrate 63 is determined by an image positioner, which consists of several elements. A linear translation stage 90 moves the optical head across the surface of the substrate, a rotation stage 91 rotates the cylinder to a new location and a pair of galvo or electro optical scanners 92 moves the image to quickly write a small subfield of dots before the translation stages move to a new location.

The entire system is controlled by a computer 70. The computer 70 allows the generation of artwork in Photoshop™ or other formats and converts this image into a machine-readable set of instructions. The computer also controls all of the subsystems, including the laser beam generator 10, the beam shaper 20, the beam control, 80, the spatial light modulator 30, the lens and autofocus 42 and the image positioning equipment 90, 91 and 92 to produce the final holographic artwork. Additional subsystems such as safety interlocks, a debris remover to remove laser generated debris, an image monitoring system, or a distributed automation system are included as necessary to improve performance or allow safe operation of the system. These subsystems, when employed, are controlled or monitored by the computer and automated system control.

In all of the four above mentioned designs, where the spatial light modulator 30 is a Fabry-Perot Etalon Design, a Mask Based Scanning Design, a Liquid Crystal Display (LCD) Design, Digital Micro-Mirror Device, or a Twyman-Green (or Michelson) Interferometer Design, the main objective is to use light, preferably from a laser, to write gratings on the surface of a substrate or film. This is accomplished by spatially modulating the intensity of the light in such a way that there are bright and dark fringes. When these fringes are imaged on the substrate or film, an image of these fringes can be recorded on the surface by either photochemical methods or ablation of the material.

In an exemplary method, these fringe patterns are imaged in small areas (pixels) (on the order of 10's to 100's of microns) with fringes having periods of about 0.5 to 2 micron. These pixels are arranged in a dot matrix type of pattern to cover the surface of the substrate and produce any type of desired pattern, where the period and depth of each of the grating pixel produced can also be varied. The individual pixels are placed on the substrate by an automated system such as shown in FIG. 1, where 2 scanners with their axes of scanning at 90 degrees to each other along with several other optical components are used to address a surface area to be patterned. All four of these designs can serve as the spatial light modulator 30 as shown in FIG. 1.

The first major component of the exemplary design shown in FIG. 1 is the laser 10, which is chosen based on the requirements of the material in which the holographic pattern will be written. Those skilled in the art will recognize that if a photoresist is used, the laser needs to be compatible in wavelength and power to sensitize the photoresist for later development. The laser used in this case can be chosen from a variety of CW (continuous-wave) or pulsed lasers. If the material is to be ablated, the laser is typically a pulsed laser with higher power requirements based on if the material is a polymer, metal, ceramic, etc. Short pulse and UV lasers are in general preferred for this type of ablative writing. Those skilled in the art will recognize that depending on the type of surface to be treated and other factors such as desired imaging speed, grating quality and cost, the laser 10 can include any of the following types: a CW laser, a quasi-CW laser, a pulsed laser, an ultraviolet (UV) laser, a diode pumped solid state (DPSS) laser, a DPSS laser with Harmonic generation in the Visible light range, a DPSS UV laser with Harmonic generation in the Near UV light range, a DPSS UV laser with Harmonic generation in the Deep-UV light range, an excimer laser, a Nd:YAG laser, a nanosecond pulsed laser, picosecond pulsed laser or a femtosecond pulsed laser.

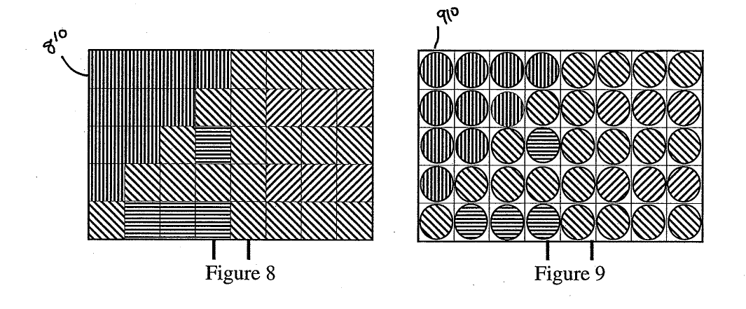

The second major component of the exemplary design shown in FIG. 1 is the beam shaper 20. Since laser beams typically have Gaussian intensity profiles, the illumination over the field to be exposed is not uniform. It is desirable to make the intensity flat and uniform. This is possible using a single or combination of optical elements to approximate a flat top type intensity distribution. To completely fill the space in the holographic artwork, it is also desirable to have a space filling shape such as a square, or hexagon. FIG. 8 shows how a square shape 810 can have nearly a 100% fill factor without dot overlap while, as shown in FIG. 9, circular dots 910 in a rectangular array (shown) have only a 78.5% fill factor without dot overlap, other close-packed arrays of circular dots can have a fill factor up to 90.7%. It is important that the maximum area be filled with the holographic gratings have the maximum diffraction efficiency and optical brightness. This square 810 or circular shape 910 can be accomplished with an aperture in the laser beam path imaged onto the target. Beam shapers can include: a beam expander, a beam collimator, a beam condenser, a beam apodizer, a beam polarizing optic, a beam depolarizing optic, a beam homogenizer, an aspheric optic, or a diffractive optic. These devices may be used singly or in combination with each other. Moreover, these components and devices and techniques for combining them are well known to those skilled in the art.

The third major component of the exemplary design shown in FIG. 1 is the spatial light modulator 30. This component determines the pattern that will be written in each dot. This pattern is produced at a location removed from the substrate surface and then is imaged onto the substrate surface 63 There are a number of components, which can be chosen to accomplish this with various limitations. The most desirable include various designs of a Fabry-Perot etalon, a mask based System, a Liquid Crystal Display (LCD), a Digital Micro-Mirror Device, or a Twyman-Green (or Michelson) Interferometer. Other embodiments of the spatial light modulator 30 can include devices such as a holographic optical element, a slit or slits, gratings or a Billet's split lens, all of which are known to those skilled in the art. The major criteria for selection of a spatial light modulator are the wavelength and coherence length of the laser used, quality of the pattern that can be produced, and the speed at which the pattern can be changed.

The fourth major component of the exemplary design shown in FIG. 1 is the imaging optical system 40. This component images the pattern onto the substrate 63 to write each holographic dot. In general, the pattern that is generated by the spatial light modulator is larger than the desired size of the dot 64 that will be written on the substrate 63. In a typical embodiment, the imaging optical system comprises a de-magnifying optical system, which faithfully reduces the pattern to the desired size at the substrate 63.

The fifth major component of the exemplary design shown in FIG. 1 is the laser beam control 80, which controls the laser exposure onto the substrate. This can be accomplished by a variety of devices including an electro-optical shutter, acousto-optical shutter or a mechanical shutter. The exposure can be controlled for a CW laser by controlling the time of exposure or varying the intensity of the laser beam. For pulsed lasers, the exposure can also be controlled by controlling the number of pulses per exposure. The exposure determines the depth of the grating for surface relief holograms. FIG. 11 shows gratings made with an embodiment of the present invention and showing high accuracy and high uniformity. Pixels 1010 are 50 μm square and the grooves 1020 are spaced 0.5 μm apart. There is an optimum grating depth to produce the maximum diffraction efficiency for each wavelength of light. This can be optimized for visible light wavelengths to control the visual appearance of the holographic patterns. The embodiments described herein, by controlling the grating depth to high accuracy can in turn control the visual appearance of the holographic patterns to make uniform, high brightness, defect free, and seamless patterns.

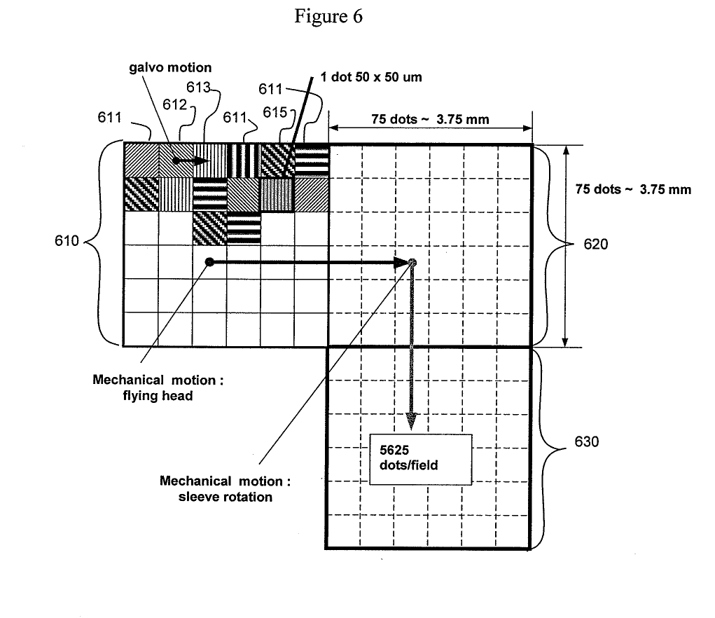

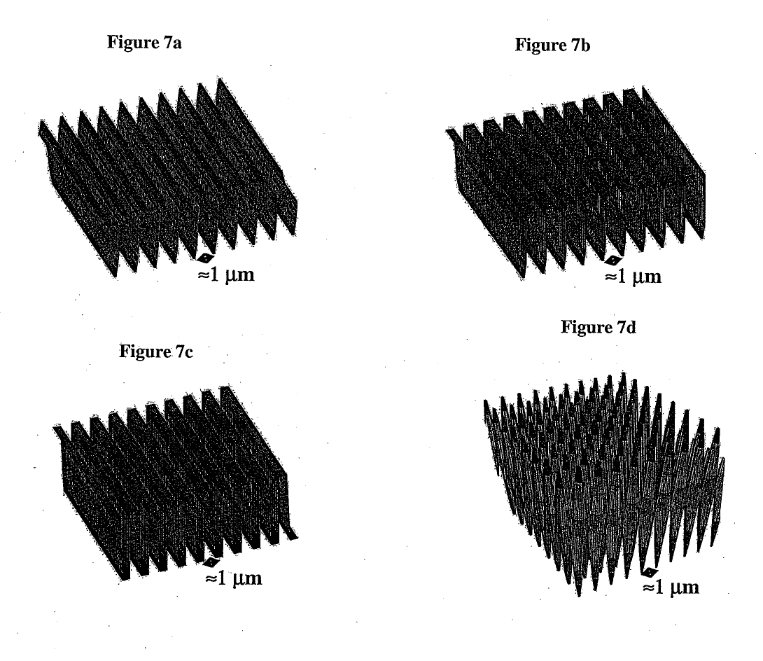

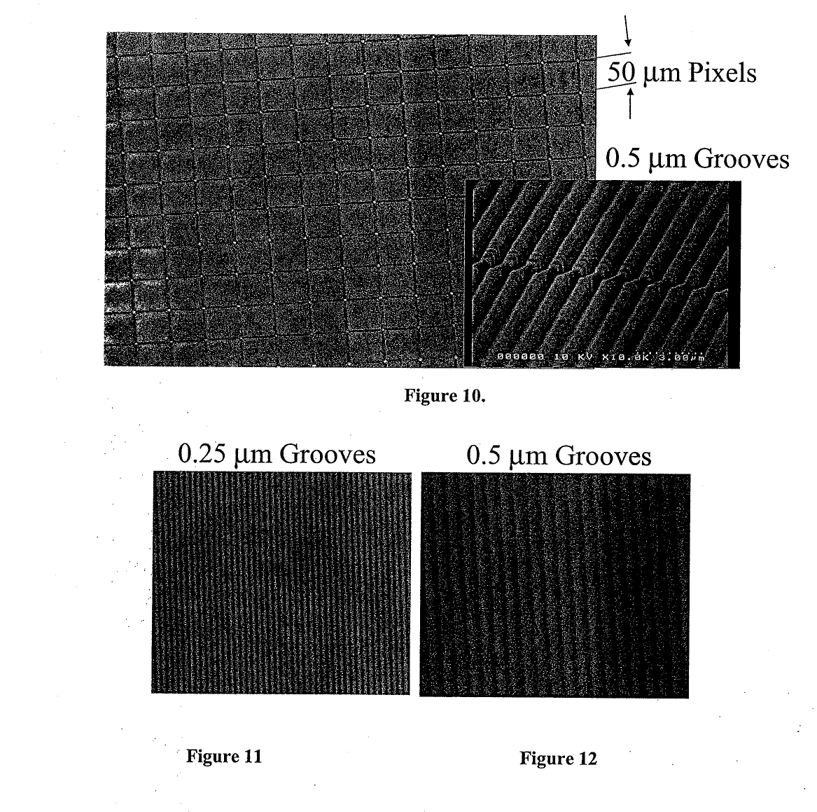

The sixth major component of the exemplary design shown in FIG. 1 is the image positioner, comprising exemplary elements, galvanometric (“galvo”) positioners 92, linear stage translator 90 and cylinder rotator 91. The image positioning components position the holographic dots 64 that are written on the substrate surface 63. A combination of (i) mechanical movement of the substrate, (cylinder rotation in embodiment shown in FIG. 1), (ii) the mechanical movement of the optical writing head by a linear stage translator 90, which is somewhat analogous to an elecromechanical print head in an ink jet or ribbon type dot matrix printer, and (iii) beam scanning by galvo or electro-optical scanners 92 can be used to write the dots across a large holographic pattern. FIG. 6 shows an exemplary high speed scanning method for a cylindrical system as shown in FIG. 1. The two galvo scanners 92 with preferably telecentric optics would write a sub-region of dots (for example a the 6×6 dot region 610 shown in FIG. 6. Positioning of each of the dots 611 to 616 within region 610 is done by the galvo scanners. Then either the optical writing head 40 is moved to an adjacent region by the linear stage translator 90, for example, to write to sub-region 620 or the cylinder mandrel 61 would be rotated to allow writing to the next region, for example 630. The next sub-region of dots would be written and this would be repeated until the entire substrate was completely written with the holographic dots. This type of system can produce uniform holographic dots, which are precisely placed with only a small gap or overlap between the dots. This is the way that the holographic artwork shown in FIG. 10 was produced on a flat sheet of PEEK polymer. Image positioning and focusing elements can include: a one-to-one imaging system, a de-magnifying imaging system, a magnifying imaging system, an optical relay system, an auto-focus system, a laser beam shaping, forming, or collimating optic, a two-mirror x-y optical scanner and telecentric optics to address multiple mask locations, a two-mirror x-y optical scanner and telecentric optics where the mirrors are moved by galvo-actuators; or a two-mirror x-y optical scanner and telecentric optics where the mirrors are moved by piezo-actuators. Additional image positioning devices can include: a galvo-scanner, piezoelectric scanner, an acousto-optic scanner, an electro-optic scanner or a motorized device that translates and/or rotates the substrate or that translates and/or rotates the imaging optics and the spatial light modulator.

As one skilled in the art will recognize, imaging positioning and focusing elements can be adapted to allow writing to a variety of substrate shapes, including: flat sheet, a cylinder, a cylinder sleeve, a master roll for producing an embossing roll to be used for replication, or an embossing roll.

The seventh major component of the exemplary embodiment shown in FIG. 1 is the automated computer control system 70. The computer allows the generation of artwork in Photoshop™ or other formats and converts this image into a machine-readable set of instructions. The computer then controls all of the above-described subsystems to produce the final holographic artwork. Additional subsystems such as safety interlocks; an autofocus control; a laser beam power control; a cylinder diameter monitor and compensation control; vibration isolation, sensing or control; a temperature control; a laser safety enclosure; a debris remover to remove laser-generated debris; an image monitoring system such as a pattern monitor or an interferometer fringe pattern monitor comprising a beam splitter and a camera; or a distributed automation system can be included as necessary to improve performance or allow safe operation of the system. These subsystems would be controlled or monitored by the computer and automated system control.

Also shown in FIG. 1 is the substrate 63 that the dot matrix holographic pattern is written on. The substrate can be composed of a number of materials including: polymers, metals, ceramics, photoresist-coated polymers, ceramics or metals; or polymer-coated ceramics or metals. The substrate can also be in various shapes such as a flat sheet, a cylinder or a cylinder sleeve. The type of material chosen will determine the type of laser needed for the system. In general, a polymer material is preferred because polymers are known to be good candidates for laser ablation and can be made photosensitive. They can also be made into the shapes needed and have desirable mechanical and physical properties.

A number of substrates are known to be good candidates for laser ablation. These include: aromatic polyetheretherketone, aromatic polyimide, aromatic polyamide and aromatic polysulfone. Based on experimentation, potentially good ablation candidates include the following properties a) Presence of an aromatic ring structure in the backbone of the polymer chain, and b) Presence of a “weak-link” chemical bond in the backbone of the polymer chain (examples of relatively weak chemical bond linkages such as C-N and C-O. This disclosure is not meant to limit the extent of useful substrates, as many other substrate materials are possible candidates for laser ablation assuming the appropriate laser, laser beam shape, and laser fluence, are used. Potential additional candidate materials include other polymers, metals and ceramics.

Since one objective of this system is to produce a master artwork that can be used to mass-produce the holographic pattern at a low cost, the preferred type of grating is a surface relief grating such as is shown in FIGS. 10 and 11. Because of the time and expense to produce dot matrix holograms, dot matrix holograms are typically produced as masters, which are replicated to produce the final holographic product. The most widespread method of replication for production is embossing into a polymer film. To do this the dot matrix holograms need to be surface relief holograms. This is the master artwork, which is then typically replicated into a triacetate or metal shim to produce a sub-master. This sub-master can be used for direct embossing or it can be replicated a second or even third time to produce the final artwork for embossing. The ability to produce high quality, bright, seamless and defect free holographic artwork is essential to being successful in mass-producing holographic patterns.

The preferred embodiments of the present invention vary mainly in the way in which the interference or other pattern is generated and how it is delivered to the substrate surface where the pattern will be written. There are trade offs of speed versus versatility between these designs. However, it is possible to combine one or more of these designs within one system to be able to switch between making patterns at high speed and producing highly specialized holographic artwork. For example, one may combine a mask and an etalon to get variable results on one image.

A variety of combinations of these embodiments can be envisioned. The most useful would be to combine a mask based design with an etalon design. Having an etalon would allow the rapid production and control of fringes. This would allow the holographic gratings to be written rapidly and so allow the production of large area optically variable devices, optically variable media, dot matrix holograms or embossing substrates. Having a mask capability would allow non-fringe shapes to be written. These could include security features, company logos, specialized artwork, Fresnel type lenses, etc. The mask does not allow as fast access as the etalon but is more versatile. These could be combined by having both capabilities in one system. The most effective way to implement this would be to have the etalon write all of the fringes, then the etalon could be translated out of the way and the mask could be moved into position. Then all of the mask based patterns could be written. This would allow the optimum use of the speed of the etalon and the versatility of the mask.

### Fabry-Perot Interferometer-Based Spatial Light Modulator

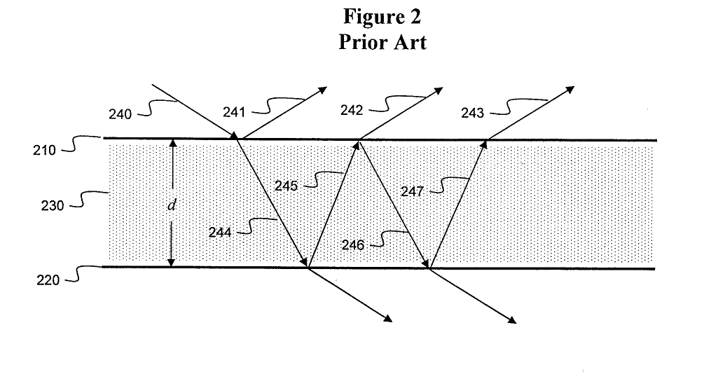

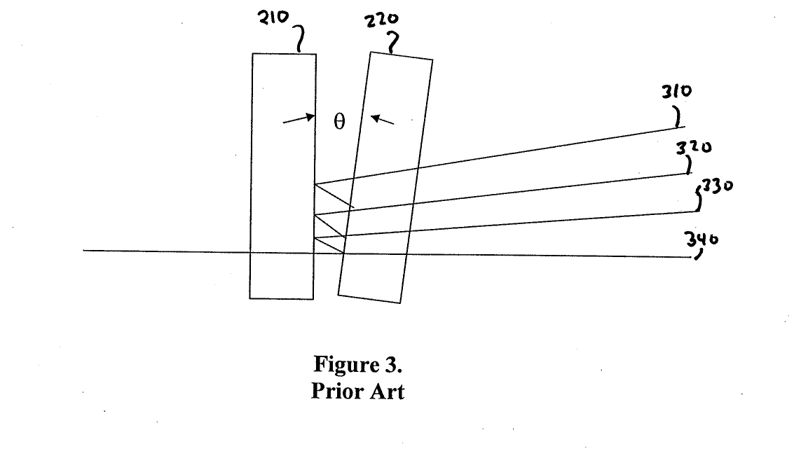

One embodiment of a spatial light modulator 30 used to produce a grating image is a Fabry-Perot Etalon. The principle of a Fabry-Perot Etalon is shown in FIG. 2. The fringe pattern, illustrated by light rays 241, 242, 243 is created by the transmission 244 of light ray 240, which causes multiple reflections 245, 246, 247 from the two reflecting surfaces 210, 220 of the etalon 200. The advantage of the etalon design is that only the tilt of one of the etalon's mirrors (210 or 220) needs to be adjusted to make any grating orientation or period that is required. This is illustrated in FIG. 3. The angle of the tilt 0 controls the fringe spacing and the direction of the tilt controls the orientation of the fringes 310, 320, 330 and 340. Piezoelectric or other fast actuators can control the tilt of the etalon mirror. Such actuators can be very fast, reproducible, and precise. The etalon produces bright and dark fringes. The bright fringes will have high brightness and the dark fringes will be very dark to give the best contrast ratio. The Fabry-Perot etalon design produces a fringe pattern at the etalon itself and then the fringe pattern is imaged onto the cylinder sleeve (substrate) as in FIG. 1.

The principle of the etalon is that the varying transmission function of an etalon is caused by interference between the multiple reflections of light from the two reflecting surfaces. Constructive interference occurs if the transmitted beams are in phase, and this corresponds to a high-transmission peak of the etalon. If the transmitted beams are out-of-phase, destructive interference occurs and this corresponds to a transmission minimum. Whether the multiply-reflected beams are in-phase or not depends on the wavelength (λ) of the light, the angle the light travels through the etalon (θₜ), the thickness of the etalon (d) and the refractive index of the material 230 between the reflecting surfaces 210 and 220.

The phase difference between each succeeding reflection is given by δ:

$$δ = ( \frac{2 π}{λ} ) 2 nd cos {θ}_{t} \pm π$$

where the term 2nd cos θₜ is equal to the optical path length of a double traversal of the etalon plate, and the additional π is the result of phase reversal in one of two interfaces. If both surfaces have a reflection coefficient R, the transmission function of the etalon is given by:

$${T}_{e} = {[ 1 + \frac{4 R}{{( 1 - R )}^{2}} {sin}^{2} ( \frac{δ}{2} ) ]}^{- 1}$$

Maximum transmission (Tₑ=1) occurs when the optical path-length difference (2nd cos θₜ) between each transmitted beam is an integer multiple of the wavelength. In the absence of absorption, the reflectivity of the etalon Rₑ is the complement of the transmission, such that Tₑ+Rₑ=1. The maximum reflectivity is given by

$${R}_{max} = \frac{4 R}{{( 1 + R )}^{2}}$$

and this occurs when the path-length difference is equal to half an odd multiple of the wavelength.

When a small tilt is introduced between the two surfaces of the Fabry-Perot etalon, the thickness of interferometer d varies across its aperture. For a given observation angle, instead of being uniformly bright or dark, the observed pattern will consist of parallel fringes with constant spacing. In order to avoid undesired overlap of fringes from multiple diffraction angles, the magnitude of thickness, d, should be small. In other words, the common phase δ needs to vary slowly with angle θₜ. For example, a 10° separation between diffraction angles at θₜ˜90° for visible wavelengths requires the thickness, d, to be about 3 um.

The Fabry-Perot etalon design has the advantages of creating high contrast fringes and changing the period and orientation of those fringes very quickly. This allows each dot to be written very quickly, so that a system can be made in which each dot can be individually controlled in any desired combination and to allow the production of large area holographic artwork in a matter of hours or days. In addition, since a dot can be written more than once with a different grating pattern, dots having biaxial gratings, white light grating, or other multiple gratings can be produced effectively and efficiently.

One skilled in the art will recognize that the Fabre Perot etalon (“FPE”) can include any of the following types of etalons: an FPE with one tiltable mirror, an FPE with two tiltable mirrors, an FPE with maximum fringe contrast, an FPE with optimal fringe contrast adapted to set the fringe contrast by mirror reflectivity optimized for contrast and light efficiency, an FPE designed to operate in a reflection mode, an FPE designed to operate in a transmission mode, an FPE having an aperture for producing an adjustable number of fringes across the aperture, an FPE designed to produce a specific number of fringes, an FPE designed to produce between 50 and 80 bright dark pairs of fringes, or an FPE actuated by a piezoelectric transducer.

### Twyman Green or Michelson Interferometer-Based Spatial Light Modulator

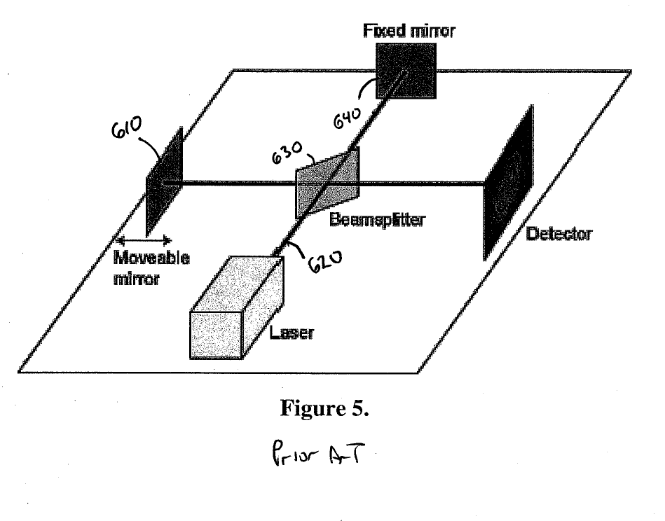

In an embodiment employing a Twyman-Green Interferometer, the spatial light modulator 30 shown in FIG. 1 is a Twyman-Green Interferometer. The principle of a Twyman-Green Interferometer is shown in FIG. 5. It is a two-beam design, where the laser beam 520 is split into 2 beams 530 and 540, which are then recombined at a location 550 removed from the recording material surface (substrate). The fringes are produced and controlled in a similar manner to the Fabry-Perot etalon design. The moveable mirror 510 in FIG. 6 is tilted to select the grating spacing and orientation. An imaging lens (not shown) is placed at the output or this interferometer to image the fringes onto the cylinder sleeve (substrate).

The Twyman-Green Interferometer embodiment is a compact, stable and simple design, which is fast and reliable. This design can also be described as essentially a Michelson Interferometer. It is as fast as the Fabry-Perot etalon design and has similar capabilities, since it uses the same fast piezoelectric actuator control for tilting the mirror. In some embodiments, the Twyman-Green Interferometer may be more susceptible to vibrations than the Fabry-Perot etalon design because the path lengths of two beams are somewhat larger. However, this can be accommodated by a design which compensates for thermal drift and vibration. In addition to the Twyman Green and Michelson interferometers that can be used as a spatial light modulator a Mach-Zender interferometer can also serve this function.

### Mask-Based Spatial Light Modulator

In an embodiment employing a scanned mask, spatial light modulator 30 shown in FIG. 1 is a mask or a mask-based scanning subsystem. In a mask-based system, an amplitude or phase mask, which contains all of the desired grating patterns, is used as a spatial light modulator 30. In this embodiment, the mask pattern is imaged by the optics onto the cylinder sleeve (substrate) 63. For example, if 50 grating periods and 100 different orientations of the gratings were desired, then 5,000 patterns would meet all of the requirements for making the desired dot gratings. (50 grating periods times 100 different orientations equals 5,000 patterns). Each pattern would be addressed by moving the mask to another pattern location using an X-Y translation stage.

One advantage of this design is that patterns which cannot be generated with the etalon or interferometer designs could be available. Each grating pattern would likely be about 500 μm×500 μm. As such, a mask, which is typically 4″ by 4″, could have over 40,000 patterns on it. This would allow as many as 35,000 additional patterns, which can be used for more grating periods, more grating orientations, different grating shapes, or other types of patterns including: biaxial gratings, miniature Fresnel lenses, white light holograms, holographic images, direct image patterns, textures, etc. For example, a design with 2 overlapping gratings at 90 degrees to each other (a biaxial or rainbow pattern) can be included. This would allow the biaxial pattern to be written in one step rather than in the two steps needed with the etalon or interferometer designs. Also, larger images, Fresnel lenses, holograms, textures, etc. can be constructed by including the appropriate set of patterns on the mask. As one skilled in the art would recognize, the limitations on the types of patterns available are be determined by the resolution of the mask and the resolution of the imaging optics in the system.

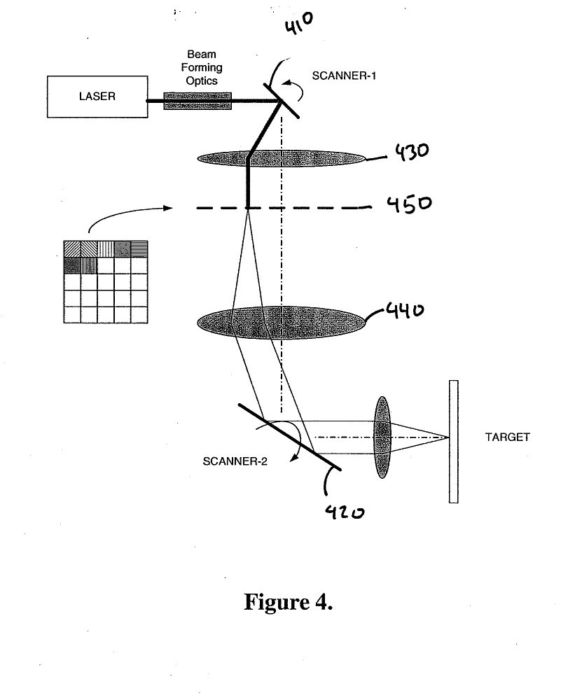

Because translating the mask is slow compared to the actuation of Fabry-Perot etalon or Twyman Green Interferometer embodiments, it is desirable to have a faster method to address the patterns on the mask. An embodiment employing a scanned mask for a spatial light modulator is shown in FIG. 4, where a pair of galvo or electro-optical scanners 410, 420 is used in conjunction with a pair of lenses 430, 440 to address a certain portion of the patterns on the mask 450. To address additional patterns, the mask is translated to allow the scanners to access an additional portion of the available patterns. The number of patterns addressable by the scanning design can be from thousands to tens of thousands of patterns depending on the scanners and the size of lenses used. Since galvo or electro-optical scanners can be very fast, this embodiment can be fast enough to write large area holographic and other types of artwork in a matter of hours to days. Types of masks that can be used include: a permanent mask with plurality of patterns, an amplitude mask; a grey scale mask, a transmission amplitude mask, a reflection amplitude mask, a phase mask, a transmission phase mask, a reflection phase mask, a mask with gratings of various orientations and periods, a mask with micro-image patterns, a variable mask, a variable transmission mask with an array of addressable pixels, a variable reflection mask with an array of addressable pixels; and a variable reflection mask with an array of addressable mirrors.

### Liquid Crystal Display (LCD) or Micro-Mirror Array Based Spatial Light Modulator

In an embodiment employing a Liquid Crystal Display (LCD) or Micro-Mirror Array the spatial light modulator shown in FIG. 1 is a Liquid Crystal Display (LCD) or Micro-Mirror Array subsystem. The LCD or Micro-Mirror Array spatial light modulator create fringe patterns or any other patterns that are desired. These patterns are imaged by the optics onto the cylinder sleeve (substrate). The design of the system is similar to the mask-based embodiment except that the patterns would be displayed on the LCD or Micro-Mirror Array by the computer. Unlike the mask-based embodiment, with a device capable of producing a variable image, such as an LCD, no translation of the spatial light modulator would be needed to change to a different pattern. In a preferred embodiment, the variable image producing element would have a refresh rate of at least 2000 times per second, which will enable rapid changes of dot pattern on the order of the speed with which the dots can be written by the laser 10. This design can be the most flexible of the embodiments described herein, since almost any fringe pattern, logo, miniature Fresnel lenses, biaxial grating, white light holograms, holographic images, direct image patterns, or textures, could be generated using the computer and written using the LCD or Micro-Mirror Array.

An LCD or Micro-Mirror Array can produce the fringe patterns or any other pattern that is desired by displaying the image of that pattern. Since LCD and Micro-Mirror Arrays are used for television and computer monitor applications, it is obvious that any image with the correct resolution can be displayed on such devices. Fringe patterns or any other pattern would simply be images stored in one of the standard image file formats, which are displayed on the LCD or Micro-Mirror Array. These patterns would then be imaged by the optics onto the cylinder sleeve (substrate) where the optically variable devices, optically variable media, dot matrix holograms or embossing substrates would be formed.

The current state of the art for LCD and Micro-Mirror Arrays does pose some limitations. Currently the highest resolution LCD Arrays have pixels about 10 μm in size with a fill factor of up to 93%. These LCD arrays require at least a 20× or higher demagnifying optical system to create fringe patterns with fringes 0.5 μm in width. This is achievable with readily available imaging optics. Micro-Mirror Arrays have pixels about 16 μm in size with a fill factor approaching 90%. These Micro-Mirror Arrays require at least a 30× or higher demagnifying optical system to create fringe patterns with fringes 0.5 μm in width. This is also achievable with readily available imaging optics. Both of these arrays have limitations in their ability to tolerate high-power laser illumination, particularly at UV wavelengths. However, Micro-Mirror Arrays can be coated with special reflective multilayer materials for UV wavelengths and LCD arrays can be made to transmit in the UV wavelengths. These limitations depend mainly on the laser fluence required for ablation of a particular material. It is expected that the state of the art in LCD and Micro Mirror Arrays will continue to improve and that the limitations noted herein will be minimize or eliminated.

FIGS. 9 and 10 shows some of the grating shapes that can be produced and FIGS. 10, 11 and 12 show actual dot matrix gratings produced by ablation using the methods of this present invention.

One skilled in the art will recognize that the systems described herein can be used to produce surface relief structures, transmission amplitude gratings, reflection gratings, transmission grey scale gratings, reflection grey scale gratings, transmission phase gratings, reflection phase gratings, or polarization gratings.

Without further elaboration, the foregoing will so fully illustrate this invention that others may, by applying current or future knowledge, readily adopt the same for use under various conditions of service.

We claim:

1. A system for treating a substrate surface comprising:
a laser beam generator,
a laser beam shaper,
a spatial light modulator, imaging optics and
an image positioner,
said laser beam generator being adapted to generate a laser beam,
said laser beam shaper being adapted for modifying the laser beam to an optimized beam profile,
said spatial light modulator being adapted for modulating said optimized beam to generate, at a place removed from the substrate surface, an optical pattern adapted to produce any of the group consisting of an optically variable device (OVD), an optically variable medium (OVM), a dot matrix hologram or an embossing substrate,
said imaging optics being adapted to provide said optical pattern onto the substrate surface and
said image positioner being adapted to position said optical pattern to different areas of the substrate surface.

2. The system of claim 1, further comprising:
a laser beam control adapted to adjust said laser beam's characteristics.

3. The system of claim 1, further comprising:
an automated controller adapted to control said spatial light modulator to change said optical pattern and further adapted to control said image positioner.

4. The system of claim 1, wherein said laser beam is adapted to ablate a substrate.

5. The system of claim 1, wherein said laser beam is adapted to expose a photosensitive layer on said substrate.

6. The system of claim 1 where in said optical pattern is adapted to create any one of the group consisting of:
a. a surface relief structure;
b. a transmission amplitude grating;
c. a reflection grating;
d. a transmission grey scale grating;
e. a reflection grey scale grating;
f. a transmission phase grating;
g. a reflection phase grating, and.
h. a polarization grating

7. The system of claim 1, further comprising a debris remover adapted to remove laser generated debris.

8. The system of claim 1 wherein said optically variable device (OVD), optically variable medium (OVM), dot matrix hologram or embossing substrate comprises a plurality of small areas.

9. The system of claim 8 wherein said optical pattern comprises a grating having a depth, a period and an orientation and wherein said spatial light modulator, and said image positioner are further adapted to vary said depth, period and orientation of said optical pattern within each of said small areas.

10. The system of claim 1 wherein said laser beam generator comprises one of the group consisting of:
a. a cw laser;
b. a quasi-cw laser;
c. a pulsed laser;
d. an ultraviolet (UV) laser;
e. a diode pumped solid-state (DPSS) laser;
f. a DPSS laser with Harmonic generation in the Visible light range;
g. a DPSS UV laser with Harmonic generation in the Near-UV light range;
h. a DPSS UV laser with Harmonic generation in the Deep-UV light range;
i. an excimer laser;
j. a Nd:YAG laser;
k. a nanosecond pulsed laser;
l. a picosecond pulsed laser; and
m. a femtosecond pulsed laser.

11. The system of claim 1 wherein said beam shaper comprises any of the group consisting of:
a. a beam expander;
b. a beam collimator;
c. a beam condenser;
d. a beam apodizer;
e. a beam polarizing optic;
f. a beam depolarizing optic
g. a beam homogenizer.
h. an aspheric optic, and
i. a diffractive optic.

12. The system of claim 1, wherein said spatial light modulator comprises a Fabry-Perot Etalon (FPE) wherein said FPE is selected from the group consisting of:
a. a FPE with one tiltable mirror;
b. a FPE with two tiltable mirrors;
c. a FPE with maximum fringe contrast;
d. a FPE with optimal fringe contrast adapted to set said fringe contrast by mirror reflectivity and wherein said FPE is optimized for contrast and light efficiency;
e. a FPE adapted to operate in a reflection mode;
f. a FPE adapted to operate in a transmission mode;
g. a FPE having an aperture and adapted to produce an adjustable number of fringes across said aperture;
h. a FPE adapted to produce a specific number of fringes;
i. a FPE adapted to produce between 50 and 80 bright dark pairs of fringes; and
j. a FPE actuated by piezoelectric transducer.

13. The system of claim 1, wherein said spatial light modulator comprises a mask, wherein said mask is selected from the group consisting of:
a. a permanent mask with plurality of patterns;
b. an amplitude mask;
c. a grey scale mask;
d. a transmission amplitude mask;
e. a reflection amplitude mask;
f a phase mask;
g. a transmission phase mask;
h. a reflection phase mask;
i. a mask with gratings of various orientations and periods;
j. a mask with micro-image patterns;
k. a variable mask;
l. a variable transmission mask with an array of addressable pixels;
m. a variable reflection mask with an array of addressable pixels; and
n. a variable reflection mask with an array of addressable mirrors.

14. The system of claim 1, wherein said spatial light modulator comprises an interferometer wherein said interferometer is selected from the group consisting of:
a. an interferometer;
b. a Twyman-Green interferometer;
c. a Mach-Zender interferometer; and
d. a Michelson interferometer.

15. The system of claim 1, wherein said spatial light modulator is selected from the group consisting of:
a. a holographic optical element;
b. a slit;
c. multiple slits;
d. multiple gratings; and
e. a Billet's split lens.

16. The system of claim 1, wherein said imaging optical system comprises any of the group consisting of:
a. a one to one imaging system;
b. a de-magnifying imaging system;
c. a magnifying imaging system;
d. an auto-focus system;
e. a laser beam shaping, forming, or collimating optic;
f. a two-mirror x-y optical scanner and telecentric optics to address multiple mask locations;
g. a two mirror x-y optical scanner and telecentric optics where the mirrors are moved by galvo-actuators; and
h. a two-mirror x-y optical scanner and telecentric optics where the mirrors are moved by piezo-actuators.

17. The system of claim 4, wherein said substrate is selected from the group consisting of;
a. a flat sheet;
b. a coated flat sheet;
c. a photoresist coated flat sheet;
d. a cylinder;
e. a coated cylinder;
f. a photoresist coated cylinder;
g. a cylinder sleeve;
h. a coated cylinder sleeve;
i. a photoresist coated cylinder sleeve;
j. a polymer coated metal cylinder sleeve;
k. a photoresist coated metal cylinder sleeve;
l. a polymer coated fiberglass sleeve;
m. a photoresist coated fiberglass sleeve;
n. a master roll adapted to produce an embossing roll adapted for replication; and
o. an embossing roll.

18. The system of claim 2, wherein said laser beam control comprises one of the group consisting of:
a. a control adapted to vary intensity and time of exposure;
b. a control adapted to pulse said laser and to vary pulse power and number of pulses;
c. an electro-optical shutter;
d. an acousto-optical shutter;
e. a mechanical shutter;
f. a control adapted to vary laser power, and
g. a control adapted to vary the laser dose.

19. The system of claim 2, wherein said image positioner comprises any of the group consisting of:
a. an optical scanner;
b. an optical scanner with telecentric optics;
c. a galvo-scanner;
d. a piezoelectric scanner;
e. an acousto-optic scanner;
f. an electro-optic scanner;
g. a motorized device adapted to translate or rotate the substrate and
h. a motorized device adapted to translate or rotate said imaging optics and said spatial light modulator.

20. The system of claim 3, wherein said automated controller comprises a computer and an image monitoring sensor.

21. The system of claim 20 wherein said image monitoring sensor comprises any of the group consisting of:
a. a drum diameter monitor and compensation system;
b. a pattern monitor;
c. an interferometer fringe pattern monitor comprising a beam splitter and a camera; and
d. a vibration sensor.

22. The system of claim 3, wherein said automated controller comprises a distributed automation system connected by a local area network.

23. The system of claim 1, wherein said image positioner is adapted to position an image on the substrate.

24. The system of claim 4, wherein said substrate is a polymer.

25. The system of claim 24 wherein said polymer is selected from the group consisting of:
a. aromatic polyetheretherketone (PEEK);
b. aromatic polyimide;
c. aromatic polyamide; and
d. aromatic polysulfone.

26. The system of claim 24 wherein the polymer contains an aromatic ring structure in the backbone of the polymer chain and the polymer contains a weak link chemical bond on the backbone of the polymer chain.

27. The polymer of claim 26, wherein said weak link chemical bond linkage is C—N or C—O.

28. A system for treating a cylindrical substrate surface comprising
a pulsed laser adapted to produce a UV laser beam;
a beam shaper and homogenizer adapted to shape said laser beam to a uniform flat-top profile;
a Fabry-Perot Etalon comprising two tiltable mirrors and adapted to modulate said laser beam to produce, at a place removed from the substrate surface, optical patterns adapted to produce any of the group consisting of an optically variable device (OVD), an optically variable medium (OVM), a dot matrix hologram or an embossing substrate;
a dual X-Y optical scanning system comprising telecentric optics adapted to move said laser beam across the substrate surface; in an x-y scanning method within a specified scanning field;
a de-magnifying imaging system adapted to provide said optical patterns onto the substrate surface, and
an image positioner adapted to position said scanning field to different areas of the cylindrical substrate surface.

29. A system for treating a cylindrical substrate surface comprising;
a pulsed laser adapted to produce a laser beam;
a beam shaper and homogenizer adapted shape said laser beam to a flat top profile;
a mask comprised of multiple optical pattern masks and located at a place removed from the substrate surface and adapted to modulate said laser beam to produce at a place removed from the substrate surface optical patterns adapted to produce any of the group consisting of an optically variable device (OVD), an optically variable medium (OVM), a dot matrix hologram or an embossing substrate;
an x-y translation stage adapted to move said mask to align one of said multiple optical pattern masks with said laser beam;
a dual X-Y optical scanning system adapted to move said laser beam across the substrate surface; in an x-y scanning method within a specified scanning field,
a de-magnifying imaging system adapted to provide said optical patterns onto the substrate surface; and
an image positioner adapted to position said scanning field to different areas of the cylindrical substrate surface.

30. A system for treating a cylindrical substrate surface comprising;
a pulsed laser adapted to produce a TV laser beam;
a beam shaper and homogenizer adapted shape said laser beam to a flat top profile;
a variable mask comprising an array of addressable elements, adapted to modulate said laser beam to produce at a place removed from the substrate surface optical patterns adapted to produce any of the group consisting of an optically variable device (OVD), an optically variable medium (OVM), a dot matrix hologram or an embossing substrate and further adapted to change said optical patterns.
a dual X-Y optical scanning system with telecentric optics adapted to move said laser beam across the substrate surface; in an x-y scanning method within a specified scanning field;
a de-magnifying imaging system adapted to provide said optical patterns onto the substrate surface; and
an image positioner adapted to position said scanning field to different areas of the cylindrical substrate surface.

31. The system of claim 30, wherein said array of addressable elements is an LCD array.

32. The system of claim 30, wherein said array of addressable elements is a micro mirror array.

33. A system for treating a cylindrical substrate surface comprising;
a pulsed laser adapted to produce a UV laser beam;
a beam shaper and homogenizer adapted shape said laser beam to a flat top profile;
an interferometer, having two tiltable mirrors and adapted to modulate said laser beam to produce at a place removed from the substrate surface optical patterns adapted to produce one of the group consisting of an optically variable device (OVD), an optically variable medium (OVM), a dot matrix hologram or an embossing substrate, wherein said interferometer is further adapted to change said optical patterns;
a dual optical scanning system with telecentric optics adapted to move said laser beam across the substrate surface; in an x-y scanning method within a specified scanning field;
a de-magnifying imaging system adapted to provide said optical patterns onto the substrate surface; and
an image positioner adapted to position said scanning field to different areas of the cylindrical substrate surface.

34. The system of claim 33 wherein said interferometer is a Twyman-Green interferometer.

35. A method for treating a substrate surface comprising:
generating a laser beam having a laser beam fluence;
shaping said laser beam to create an optimized laser beam;
modulating said optimized beam to generate, at a place removed from the substrate surface, an optic pattern adapted to produce any of the group consisting of an optically variable device (OVD), an optically variable medium (OVM), a dot matrix hologram or an embossing substrate,
imaging said optical pattern onto the substrate surface with imaging optics and
positioning said optical pattern to different areas of the substrate surface with an image positioner.
